(19) United States
(12) Patent Application Publication
(10) Pub. No.: US 2010/0284364 A1
(43) Pub. Date: Nov. 11, 2010

(54) SEMI-PERSISTENT SCHEDULING METHOD AND APPARATUS BASED ON STATISTICALLY MULTIPLEXING IN TIME AND FREQUENCY RESOURCES

(76) Inventors: Mingli You, Shanghai (CN); Yan Zhao, Shanghai (CN); Tao Yang, Shanghai (CN)

Correspondence Address: FAY SHARPE/LUCENT, 1228 Euclid Avenue, 5th Floor, The Halle Building, Cleveland, OH, 44115-1843, US

(21) Appl. No.: 12/811,045

(22) PCT Filed: Dec. 29, 2007
(86) PCT No.: PCT/CN07/03957

§ 371 Date: Jun. 28, 2010

(51) Int. Cl. H04W 72/04

(52) U.S. Cl. 370/330

(57) ABSTRACT

A semi-persistent scheduling method and apparatus based on statistically multiplexing in time and frequency resources, the method comprises steps of: allocating each initial transmission to use fixed time and frequency resources reserved for initial transmission by using a persistent grant, and allocating each retransmission to use time resource reserved for retransmission by using a persistent grant and dynamically allocating each retransmission to use frequency resource reserved for retransmission by using a dynamic grant or a default grant, wherein the initial transmission and the retransmission share the frequency resources within the same time slot.

### BACKGROUND OF THE INVENTION

1. Field of Invention

The present invention relates to the wireless communication field, and more particularly, to a semi-persistent scheduling method and apparatus based on statistically multiplexing in time and frequency resources which is used to share Hybrid Automatic Repeat reQuest (HARQ) process resource in uplink Voice over IP (VoIP) semi-persistent scheduling.

2. Description of Prior Art

All services will be carried in packet domain in Long Term Evolution (LTE) system and Voice over IP (VoIP) is an important service for operators. The scheduling is critical to improve the VoIP capacity with respect to the Quality of Service (QoS) and channel information. From current 3^{rd} Generation Partnership Project (3GPP) status on UpLink (UL) Scheduling Principles:
1. evolved Node B (eNB) can allocate predefined uplink resources for the first Hybrid Automatic Repeat reQuest (HARQ) transmissions and the retransmissions to User Equipments (UEs).
2. Dynamic scheduling can override the pre-defined allocation (persistent allocation) for that Transmission Time Interval (TTI). eNB can dynamically allocate resources (Physical Resource Blocks (PRBs) and Modulation Coding Scheme (MCS)) to UEs at each TTI via the Cell-Radio Network Temporary Identifier (C-RNTI) on L1/L2 control channel.

With the standards defined in 3GPP, there could be 3 potential scheduling modes for uplink VoIP scheduling:
1. Persistent scheduling which only L3 signaling allows;
2. Dynamic scheduling which only allows to use the L1/L2 grant same with the grant used for burst packet services such as Best effort;
3. Semi-persistent scheduling which allows to use persistent grant for initial transmission and dynamic grant for retransmissions.

It is expected to support up to 400 users at the same time. Thereafter, specifically for uplink, in order to support such large number of VoIP users, it will consume large number of grants which will directly reduce the downlink (DL) capacity.

The major challenge for VoIP scheduling is to increase the system capacity with limited cost of dynamic downlink (DL) grant signaling. With the constraints on dynamic grant method above, to save the downlink (DL) L1 capacity, dynamic scheduling mode isn't preferred for VoIP services. As a sequence, it becomes an issue to leverage the unused HARQ transmission for each HARQ process.

In LTE system, low average transmission number will have high spectrum efficiency with adaptive modulation and coding schemes. Thus the average HARQ transmission number will be typically between 1 and 2 to achieve good spectrum efficiency. In other side, the maximum transmission number will be large (such as 4 or 5) for VoIP service. How to sufficiently leverage the resource in HARQ transmission is still an open point.

To improve the resource utilization, there is a proposal from Motorola [Reference 1] to use dynamic grouping scheduling to group a number of VoIP users to share the resources. Different users should use same MCS and same resource units in one group and thus a number of groups can be defined with different MCS and RU (resource unit) number. However, this proposal needs specific bit-map dynamic grant to indicate which VoIP user in the group will use the time/frequency resource.

This conflicts with current grant method in 3GPP and this proposal isn't selected in 3GPP now.

There is another proposal from Alcatel-Lucent [Reference 2] to share the HARQ resource with non-VoIP user. The basic idea is to let the dynamic users use the unused HARQ retransmission opportunities for VoIP (due to successfully transmission of the VoIP packet) to transmit other packet service and when there is a collision, the VoIP packet initial transmission is shifted in time domain. But in frequency-domain, the VoIP packet will use the same resource unit and same MCS. With this approach, the time resource for initial transmission isn't persistent and VoIP service and other dynamic packet services share the same frequency resource. This seems also not feasible from current 3GPP status and system design viewpoint in the case that there is different Bandwidth allocated to VoIP services and other burst services.

Although principally, it is possible to apply dynamic scheduling for VoIP services as other dynamic packet services such as best effort, with consideration on strict latency and requirement to support large number of VoIP users simultaneously, this pure dynamic scheduling mode is totally not efficient from signaling cost viewpoint and thus not a preferred solution at least for LTE R8.

How to improve the resource utilization of VoIP packet HARQ transmission is still an open point.

In this invention, an enhanced semi-persistent scheduling method based on statistically multiplexing in time and frequency resources are proposed with its target to achieve good trade-off between the system VoIP capacity and reasonable grants cost.

### SUMMARY OF THE INVENTION

This basic idea of the present invention is to statistically leverage the unused HARQ transmission opportunities through TDM and FDM among VoIP UEs in the semi-persistent scheduling mode for uplink VoIP scheduling.

In details, according to a first aspect, the present invention proposes a semi-persistent scheduling method based on statistically multiplexing in time and frequency resources, comprising steps of: allocating each initial transmission to use fixed time and frequency resources reserved for initial transmission by using a persistent grant; and allocating each retransmission to use time resources reserved for retransmission by using a persistent grant and dynamically allocating each retransmission to use frequency resources reserved for retransmission by using a dynamic grant or a default grant, wherein the initial transmissions and the retransmissions share the frequency resources within the same time slot.

Preferably, the initial transmissions are uniformly distributed into different time slots.

Preferably, the fixed frequency resources allocated for the initial transmissions in each time slot are in a random manner or a cyclic-shift manner.

Preferably, the time resources are different time slots, and the frequency resources include different modulation coding schemes and different resource units. More preferably, the time resources are allocated in a persistent scheduling mode by using the persistent grant, whereas the frequency resources reserved for the initial transmissions are allocated in a persistent scheduling mode by using the persistent grant, and the frequency resources reserved for the retransmissions are allocated in a dynamic scheduling mode by using the dynamic grant or the default grant. More preferably, the modulation coding scheme and the number of the resource units allocated to the retransmission are dynamically changed by the dynamic grant. More preferably, the modulation coding scheme and the number of the resource units allocated to the initial transmission are slowly changed by the persistent grant.

Preferably, the semi-persistent scheduling method further comprises a step of assigning a first priority to the initial transmissions and a second priority to the retransmissions, in which the first priority is higher than the second priority.

Preferably, the semi-persistent scheduling method further comprises: a step of reallocating the sizes of the resource units, when there is a peak retransmission burstness; or a step of temporally pausing a retransmission by using a “stop” grant in a current time slot while maintaining its retransmission opportunity in the next time slot, when there is a peak retransmission burstness. More preferably, the “stop” grant is a general dynamic grant with a “zero” resource unit number and a “zero”-numbered modulation coding scheme.

Preferably, the semi-persistent scheduling method further comprises a step of measuring an unused resource unit number during a predetermined measurement period, in which the unused resource unit number is an average number of the resource units which have not been used during the predetermined measurement period. More preferably, the semi-persistent scheduling method further comprises a step of switching one user equipment into the persistent scheduling mode if the measured unused resource unit number is larger than a first predetermined threshold.

Preferably, the semi-persistent scheduling method further comprises a step of measuring an unable retransmission number during a predetermined measurement period, in which the unable retransmission number is an average number of the unsatisfied retransmissions during the predetermined measurement period. More preferably, the semi-persistent scheduling method further comprises a step of switching one user equipment out of the persistent scheduling mode if the measured unable retransmission number is larger than a second predetermined threshold.

Preferably, the semi-persistent scheduling method is used for an uplink voice over IP service.

On the other hand, according to a second aspect, the present invention also proposes a semi-persistent scheduling apparatus based on statistically multiplexing in time and frequency resources, comprising: an initial transmission allocating means for allocating each initial transmission to use fixed time and frequency resources reserved for initial transmission according to a persistent grant; and a retransmission allocating means for allocating each retransmission to use time resources reserved for retransmission according to a persistent grant and dynamically allocating each retransmission to use frequency resources reserved for retransmission according to a dynamic grant or a default grant, wherein the initial transmission allocating means and the retransmission allocating means cooperatively allocate the resources so that the initial transmissions and the retransmissions share the frequency resources within the same time slot.

Preferably, the initial transmission allocating means uniformly distributes the initial transmissions into different time slots.

Preferably, the initial transmission allocating means allocates the fixed frequency resources for the initial transmissions in each time slot in a random manner or a cyclic-shift manner.

Preferably, the time resources are different time slots, and the frequency resources include different modulation coding schemes and different resource units. More preferably, the initial transmission allocating means allocates the time and frequency resources in a persistent scheduling mode according to the persistent grant, whereas the retransmission allocating means allocates the time resources in a persistent scheduling mode according to the persistent grant and allocates the frequency resources in a dynamic scheduling mode according to the dynamic grant or the default grant. More preferably, the retransmission allocating means dynamically changes the modulation coding scheme and the number of the resource units to be allocated to the retransmission according to the dynamic grant. More preferably, the initial transmission allocating means slowly changes the modulation coding scheme and the number of the resource units to be allocated to the initial transmission according to the persistent grant.

Preferably, the semi-persistent scheduling apparatus further comprises a priority assigning means for assigning a first priority to the initial transmissions and a second priority to the retransmissions, in which the first priority is higher than the second priority.

Preferably, the semi-persistent scheduling apparatus further comprises: a means for reallocating the sizes of the resource units, when there is a peak retransmission burstness; or a means for temporally pausing a retransmission by using a “stop” grant in a current time slot while maintaining its retransmission opportunity in the next time slot, when there is a peak retransmission burstness. More preferably, the “stop” grant is a general dynamic grant with a “zero” resource unit number and a “zero”-numbered modulation coding scheme.

Preferably, the semi-persistent scheduling apparatus further comprises a first measuring means for measuring an unused resource unit number during a predetermined measurement period, in which the unused resource unit number is an average number of the resource units which have not been used during the predetermined measurement period. More preferably, the semi-persistent scheduling apparatus further comprises a first switching means for switching one user equipment into the persistent scheduling mode if the measured unused resource unit number is larger than a first predetermined threshold.

Preferably, the semi-persistent scheduling apparatus further comprises a second measuring means for measuring an unable retransmission number during a predetermined measurement period, in which the unable retransmission number is an average number of the unsatisfied retransmissions during the predetermined measurement period. More preferably, the semi-persistent scheduling apparatus further comprises a second switching means for switching one user equipment out of the persistent scheduling mode if the measured unable retransmission number is larger than a second predetermined threshold.

Preferably, the semi-persistent scheduling apparatus is used in an uplink voice over IP system.

In the semi-persistent scheduling mode, multiple VoIP users share the same HARQ process within one Voice Frame (20 ms) through time division multiplexing (TDM). Different VoIP UEs' initial transmission can be allocated into different time slots of the same HARQ process by using the persistent grant. In frequency-domain, the resource units (RUs) are used as pool to be shared by VoIP UEs. A part of the frequency resource (Resource Unit) is reserved for initial VoIP packet transmission and the left part will be used for VoIP packet retransmission. The RUs reserved for initial transmissions are allocated by persistent grant and the RUs for retransmissions are statistically shared among different VoIP UEs using dynamic grant. The frequency-domain shifting can be used to avoid the confliction between retransmission and initial transmission.

To well balance the ratio of RUs for initial transmission and RUs for retransmissions, there introduces a outer control loop to well adjust the balance between the number of supportable VoIP users within one HARQ process and the outage probability of VoIP service by monitoring the “unused resource unit” and “unable HARQ retransmission” probability. To avoid the confliction of the burst retransmission peak, a “stop grant” can be introduced in current 3GPP-defined grant to postpone HARQ retransmission temporarily.

With the above approach according to the present invention to improve resource utilization for HARQ process for semi-persistent uplink VoIP scheduling, the present invention has the following benefits:
Significantly reduce the dynamic signaling grant cost by persistently allocating multiple VoIP UEs to share the same HARQ process for their initial transmissions; In addition, the waste of unused HARQ process is minimized due to the multiplexing in time domain for initial transmissions among multiple VoIP UEs.
Further improve the VoIP capacity due to the multiplexing gain of HARQ retransmission by statistically multiplexing multiple VoIP packet retransmission in a limited frequency-domain resource pool. Since the VoIP packets retransmission is a random event, it doesn't need to reserve same number of RUs for retransmission as their initial transmissions;
Introduce a “stop” grant to avoid the confliction of initial transmission and retransmission burst peak;
The outer control loop to adjust the balance of RUs for initial transmission and retransmission can make the VoIP capacity close to the pure dynamic scheduling mode but with moderate grant cost only.

### BRIEF DESCRIPTION OF THE DRAWINGS

The above and other objects, features and advantages of the present invention will be clearer from the following detailed description about the non-limited embodiments of the present invention taken in conjunction with the accompanied drawings, in which:

FIG. 1 is a schematic diagram to overview the characteristics of the VoIP service from VoIP data source;

FIG. 2 is a flowchart to illustrate the operation following the semi-persistent scheduling method according to the present invention;

FIG. 3 is a schematic diagram to illustrate an example for statistically HARQ process sharing using TDM/FDM;

FIG. 4 is a block diagram to illustrate the structure of the semi-persistent scheduling apparatus according to the present invention; and

FIG. 5 shows the system simulation results of the inventive semi-persistent scheduling method and the comparative persistent scheduling method.

### DETAILED DESCRIPTION OF PREFERRED EMBODIMENTS

Hereunder, the present invention will be described in accordance with the drawings. In the following description, some particular embodiments are used for the purpose of description only, which shall not be understood as any limitation to the present invention but the examples thereof. While it may blur the understanding of the present invention, the conventional structure or construction will be omitted.

### 1. VoIP Service Characteristics

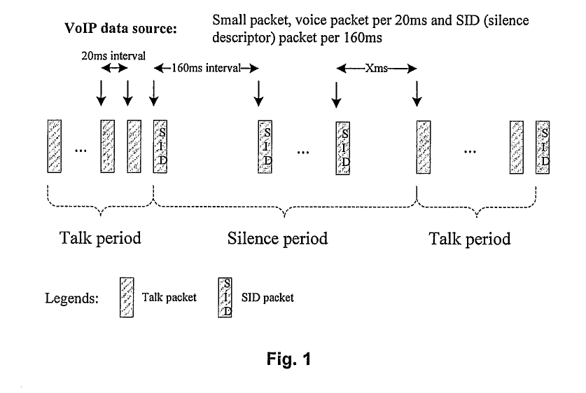

For VoIP service, there are two states either talk state or silence state. In talk state, only one VoIP packet is transmitted every 20 ms; and in silence state, one SID (silence descriptor) packet is transmitted every 160 ms as shown in FIG. 1. In addition, the synchronous HARQ is supported for UL VoIP transmission.

### 2. Sharing HARQ Transmission Using TDM/FDM Method for Semi-Persistent Scheduling Mode

The semi-persistent scheduling is a preferred solution for LTE uplink VoIP scheduling due to its property of good trade-off between capacity and dynamic signaling cost. The traditional approach for semi-persistent scheduling is to reserve the first time slot within HARQ process for initial transmission and the left time slots will be reserved for HARQ retransmission. If the VoIP packet transmission is successful, the left HARQ retransmission opportunities will be used for another VoIP user using dynamic L1/L2 grant. Then in next time slot, the new VoIP user's retransmission may conflict with the reserved initial transmission. In addition, for the same VoIP user, it is hard to determine whether its initial transmission will be dynamically scheduled through dynamic grant or will be persistent scheduled with L3 signaling.

The basic idea in this proposed approach is to share the HARQ process among multiple VoIP users in TDM to improve VoIP UE capacity while avoiding VoIP user's initial transmission to be dynamically scheduled:
Each initial transmission uses fixed time, fixed resource (RU+MCS) from persistent grant;
Multiple VoIP users can start initial transmission in different time slots in the HARQ process;
   The distribution of initial transmission should be uniform in different time slots.
Initial transmission and retransmission share the frequency resource within the same time slot: a part of resource is reserved for initial transmission and the left part will be reserved for retransmission only.
   The allocation of frequency resource in persistent scheduling for initial transmission in each time slot could be in a random or cyclic-shift manner depending on the trade-off between signaling cost for retransmission and frequency-diversity gain.
The time resource is persistent while the frequency-domain resource reallocation could be dynamic;
   Both MCS and RU number can be dynamically changed through dynamic grant for HARQ retransmission: Frequency-selective scheduling can be applied for HARQ retransmission;
   Only slowly change is allowed for initial transmission by using persistent grant.
If there is confliction between VoIP initial transmission and VoIP retransmission, the initial transmission has a higher priority than retransmission:
   The initial transmission can be guaranteed with persistent scheduling;
   If there is a peak retransmission burstness, either reallocating the RU size or temporally pausing the retransmission with “stop” grant while maintaining its retransmission opportunity in the next time slot. The “stop” grant is a general dynamic grant with “zero” RU number and MCS.

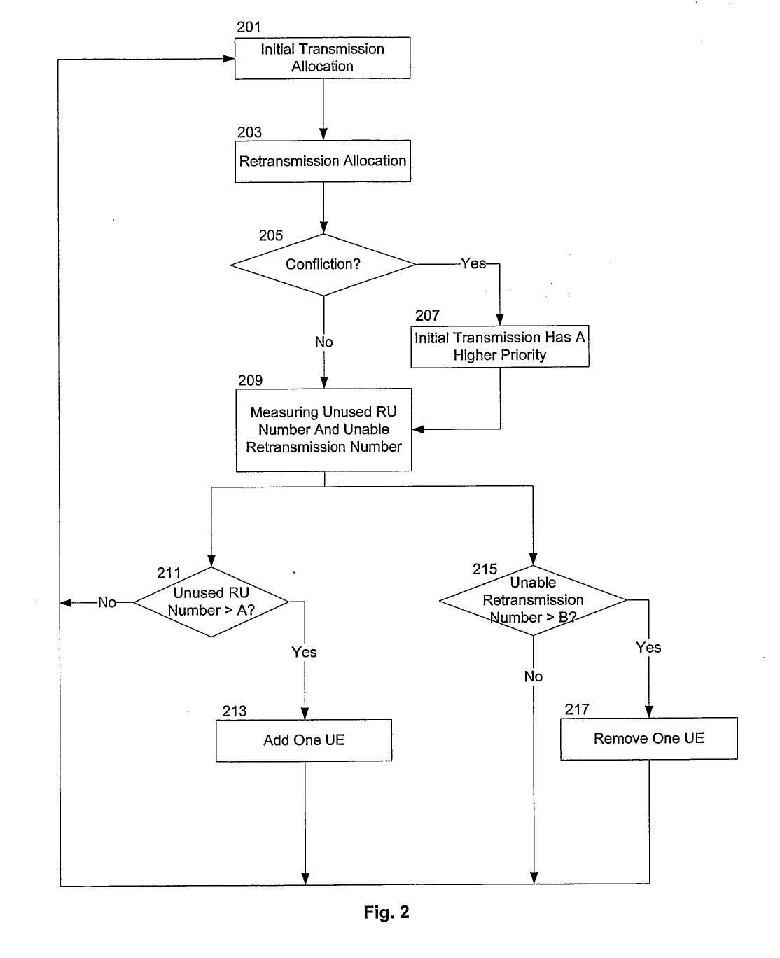

FIG. 2 is a flowchart to illustrate the operation following the semi-persistent scheduling method according to the present invention.

In details, at step 201, each initial transmission is allocated to use fixed time and frequency resources reserved for initial transmission by using a persistent grant. Then, at step 203, each retransmission is allocated to use time resources reserved for retransmission by using a persistent grant and is dynamically allocated to use frequency resources reserved for retransmission by using a dynamic grant or a default grant. Herein, the initial transmissions and the retransmissions share the frequency resources within the same time slot.

At step 205, it is judged whether the initial transmissions are conflicting with those retransmissions in a current time slot. If it is determined that these transmissions (initial transmissions and the retransmissions) are conflicting with each other (“Yes” at step 205), then at step 207, it will determine that the initial transmissions have a higher priority and will be firstly transmitted, and the retransmissions will be waiting for a next transmission opportunity coming in the next time slot. Otherwise, if it is determined that the transmissions are not conflicting with each other (“No” at step 205), then at step 209, the unused RU number and the unable HARQ retransmission number are measured during a predetermined measurement period.

Thereafter, at step 211, it is judged whether the unused RU number is larger than a predetermined threshold A (will be described later). If so (“Yes” at step 211), at step 213, one UE is added into the persistent scheduling mode, i.e., switching one UE into the persistent scheduling mode, and then the process goes back to the step 201 to perform the process with the updated UE number. Otherwise (“No” at step 211), the process directly goes back to the step 201 to perform the initial transmission allocation with the non-updated UE number.

On the other hand, at step 215, it is judged whether the unable HARQ retransmission number is larger than a predetermined threshold B (will be described later). If so (“Yes” at step 215), at step 217, one UE in the persistent scheduling mode is removed, i.e., switching one UE out of the persistent scheduling mode, and then the process goes back to the step 201 to perform the process with the updated UE number. Otherwise (“No” at step 215), the process directly goes back to the step 201 to perform the initial transmission allocation with the non-updated UE number.

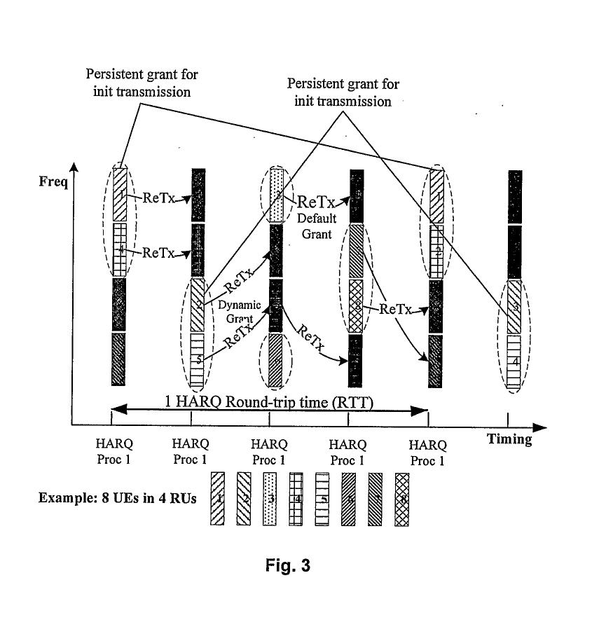

FIG. 3 illustrates an example that 8 VoIP users share the 4 RUs (resource units) with the same HARQ process 1. Several RUs (those circled with dashed ellipses) are reserved for persistent scheduling for initial transmission and the left RUs (those shaded) are used for HARQ retransmission and thus can be dynamically scheduled.

In the example shown in FIG. 3, we have 8 VoIP UEs which share the 4 Resource units (RU) in the HARQ process 1. In this example, 8 VoIP UEs' initial transmission is using persistent grant and uniformly distributed in the 4 timeslots such as,
In the first time slot of HARQ process 1, the first two resource units are reserved for UE1 and UE4 using persistent grant while the left 2 RUs are used for retransmission either by dynamic grant or default grant.
In the second time slot of HARQ process 1, the first two RUs are used for retransmission and the left 2 RUs are reserved for initial transmission of UE2 and UE5. Since the UE1 and UE4's retransmission are on the same RU and thus no need for dynamic grant which can reduce the grant overhead.
In the third time slot of HARQ process 1, similarly, two RUs are reserved for UE3 and UE6's initial transmission by persistent grant, while UE2 and UE5 have their retransmission in the remaining RUs. Here both UE2 and UE5 use different RU by dynamic grant where they can get some frequency-diversity gain through frequency-hopping manner with some grant overhead cost.
In the fourth timeslot of HARQ process 1, similarly, UE7 and UE8's initial transmission are reserved and UE3's retransmission is scheduled with default grant. The left RU is used for UE5's second retransmission and UE6 has its first transmission successfully.

With this method, the retransmissions among different VoIP UEs can be statistically multiplexed in the same HARQ process with frequency-shifting. Also with frequency-shifting, certain degree of frequency diversity gain can be achieved through frequency-hopping. The ratio between the number of RUs reserved for initial transmission and the number of RUs reserved for retransmission is determined by VoIP capacity and the configured RUs for VoIP service and can be slowly adjusted in semi-static manner as defined above.

There needs an outer control loop to manage the total number of VoIP UEs for the HARQ process in order to guarantee the target VoIP service QoS:
The number of VoIP UEs can be increased or decreased for the HARQ process depending on the measurement of “unused RU number” and “unable HARQ retransmission”;
The “unused RU number” is the average resource units which have not been used in the HARQ process during the measurement period. If “unused RU number”>threshold A, add one VoIP UE in the persistent scheduling for the HARQ process, here threshold A is a pre-defined parameter
The “unable HARQ retransmission” is the average number of unsatisfied HARQ retransmission request due to limited resource in the HARQ process during the measurement period. If “unable HARQ retransmission”>threshold B, remove one VoIP UE in the persistent scheduling for the HARQ process, here, threshold B is another pre-defined parameter.

Both threshold A and threshold B are derived from system simulations according to the trade-off between RU utilization efficiency and VoIP QoS guarantees.

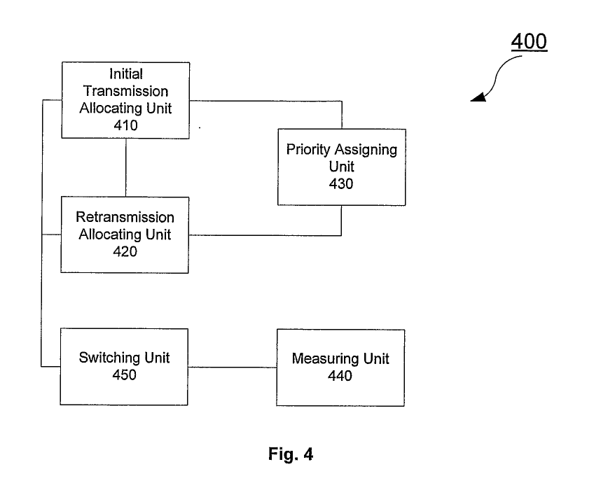

FIG. 4 is a block diagram to illustrate the structure of the semi-persistent scheduling apparatus according to the present invention.

The semi-persistent scheduling apparatus 400 according to the present invention includes an initial transmission allocating unit 410, a retransmission allocating unit 420, a priority assigning unit 430, a measuring unit 440 and a switching unit 450.

The initial transmission allocating unit 410 allocates each initial transmission to use fixed time and frequency resources reserved for initial transmission according to a persistent grant. The retransmission allocating unit 420 allocates each retransmission to use time resources reserved for retransmission according to a persistent grant and dynamically allocates each retransmission to use frequency resources reserved for retransmission according to a dynamic grant or a default grant. Herein, the initial transmissions and the retransmissions share frequency resources within the same time slot.

The priority assigning unit 430 assigns a higher priority to the initial transmissions than the retransmissions. So, when the initial transmissions are conflicting with those retransmissions in a current time slot, it will determine that the initial transmissions have the higher priority and will be firstly transmitted, and the retransmissions will be waiting for a next transmission opportunity coming in the next time slot.

The measuring unit 440 measures the unused RU number and the unable HARQ retransmission number during a predetermined measurement period.

The switching unit 450 switches the UE into/out of the persistent scheduling mode according to the measurement results of the measuring unit 440. When the unused RU number is larger than a predetermined threshold A (will be described later), the switching unit 450 adds one UE into the persistent scheduling mode, i.e., switches one UE into the persistent scheduling mode, and then notifies the initial transmission allocating unit 410 and the retransmission allocating unit 420 to perform their resource allocations with the updated UE number. On the other hand, when the unable HARQ retransmission number is larger than a predetermined threshold B (will be described later), the switching unit 450 removes one UE in the persistent scheduling mode, i.e., switches one UE out of the persistent scheduling to mode, and then notifies the initial transmission allocating unit 410 and the retransmission allocating unit 420 to perform their resource allocations with the updated UE number. Otherwise, if the unused RU number is not larger than the predetermined threshold A and the unable HARQ retransmission number is not larger than the predetermined threshold B, the switching unit 450 will perform no switching operations and notify the initial transmission allocating unit 410 and the retransmission allocating unit 420 to perform their resource allocations with the non-updated UE number.

### 3. Preliminary Simulation Results

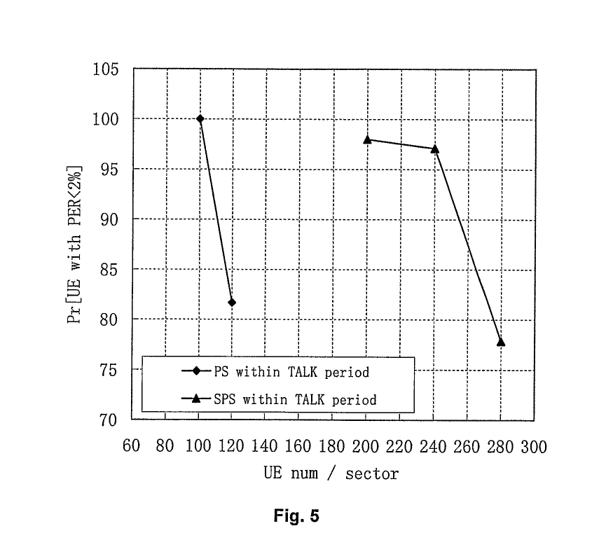

FIG. 5 shows the system simulation results of the inventive semi-persistent scheduling method and the comparative persistent scheduling method, with the following system simulation parameters:
19 cells with 3 sectors (1 cell with VoIP UEs, others with 5 Full Buffer UEs using Round-robin scheduler)
40 bytes voice packet, 15 bytes SID packet
6 HARQ processes, fixed QPSK 2/3*2 RUs for VoIP packet,
Fractional PC (Target loT 4.5 dB)
Static IC using 1/3 FFR for cell-edge UEs
Voice activity (50%)
22 RUs data transmission

In FIG. 5, UL VoIP Capacity for 12.2 Kbps AMR in Case 1 (with SID, 5 MHz Bandwidth) is about 240 UEs with satisfied VoIP QoS for the proposed semi-persistent scheduling (the middle triangle indicia). The capacity is about double as the persistent scheduling due to the efficient usage of unused HARQ resource in statistical method.

The above embodiments are provided for the purpose of example only, and are not intended to limit the present invention. It is to be understood by those skilled in the art that there may be various modifications or replacements to the embodiments without departing from the scope and the spirit of the present invention, and they shall fall into the scope defined by the appended claims.

### REFERENCE LIST

Reference 1: R2-070908 Group scheduling E-UTRA VoIP, Motorola;
Reference 2: R2-072667 Efficient Persistent UL Scheduling and HARQ Feedback Usage, Alcatel-Lucent

1. A semi-persistent scheduling method based on statistically multiplexing in time and frequency resources, comprising steps of:
allocating each initial transmission to use fixed time and frequency resources reserved for initial transmission by using a persistent grant; and
allocating each retransmission to use time resources reserved for retransmission by using a persistent grant and dynamically allocating each retransmission to use frequency resources reserved for retransmission by using a dynamic grant or a default grant,
wherein the initial transmissions and the retransmissions share the frequency resources within the same time slot.

2. (canceled)

3. (canceled)

4. (canceled)

5. (canceled)

6. (canceled)

7. (canceled)

8. The semi-persistent scheduling method according to claim 1, further comprising a step of assigning a first priority to the initial transmissions and a second priority to the retransmissions, in which the first priority is higher than the second priority.

9. The semi-persistent scheduling method according to claim 1, further comprising:
a step of reallocating the sizes of the resource units, when there is a peak retransmission burstness;
or
a step of temporally pausing a retransmission by using a “stop” grant in a current time slot while maintaining its retransmission opportunity in the next time slot, when there is a peak retransmission burstness.

10. (canceled)

11. The semi-persistent scheduling method according to claim 1, further comprising a step of measuring an unused resource unit number during a predetermined measurement period, in which the unused resource unit number is an average number of the resource units which have not been used during the predetermined measurement period.

12. The semi-persistent scheduling method according to claim 11, further comprising a step of switching one user equipment into the persistent scheduling mode if the measured unused resource unit number is larger than a first predetermined threshold.

13. The semi-persistent scheduling method according to claim 1, further comprising a step of measuring an unable retransmission number during a predetermined measurement period, in which the unable retransmission number is an average number of the unsatisfied retransmissions during the predetermined measurement period.

14. The semi-persistent scheduling method according to claim 13, further comprising a step of switching one user equipment out of the persistent scheduling mode if the measured unable retransmission number is larger than a second predetermined threshold.

15. (canceled)

16. A semi-persistent scheduling apparatus based on statistically multiplexing in time and frequency resources, comprising:
an initial transmission allocating means for allocating each initial transmission to use fixed time and frequency resources reserved for initial transmission according to a persistent grant; and
a retransmission allocating means for allocating each retransmission to use time resources reserved for retransmission according to a persistent grant and dynamically allocating each retransmission to use frequency resources reserved for retransmission according to a dynamic grant or a default grant,
wherein the initial transmission allocating means and the retransmission allocating means cooperatively allocate the resources so that the initial transmissions and the retransmissions share the frequency resources within the same time slot.

17. (canceled)

18. (canceled)

19. (canceled)

20. (canceled)

21. (canceled)

22. (canceled)

23. The semi-persistent scheduling apparatus according to claim 16, further comprising a priority assigning means for assigning a first priority to the initial transmissions and a second priority to the retransmissions, in which the first priority is higher than the second priority.

24. The semi-persistent scheduling apparatus according to claim 16, further comprising:
a means for reallocating the sizes of the resource units, when there is a peak retransmission burstness;
or
a means for temporally pausing a retransmission by using a “stop” grant in a current time slot while maintaining its retransmission opportunity in the next time slot, when there is a peak retransmission burstness.

25. (canceled)

26. The semi-persistent scheduling apparatus according to claim 16, further comprising a first measuring means for measuring an unused resource unit number during a predetermined measurement period, in which the unused resource unit number is an average number of the resource units which have not been used during the predetermined measurement period.

27. The semi-persistent scheduling apparatus according to claim 26, further comprising a first switching means for switching one user equipment into the persistent scheduling mode if the measured unused resource unit number is larger than a first predetermined threshold.

28. The semi-persistent scheduling apparatus according to claim 16, further comprising a second measuring means for measuring an unable retransmission number during a predetermined measurement period, in which the unable retransmission number is an average number of the unsatisfied retransmissions during the predetermined measurement period.

29. The semi-persistent scheduling apparatus according to claim 28, further comprising a second switching means for switching one user equipment out of the persistent scheduling mode if the measured unable retransmission number is larger than a second predetermined threshold.

30. The semi-persistent scheduling apparatus according to claim 16, wherein the semi-persistent scheduling apparatus is used in an uplink voice over IP system.
